(19) United States
(12) Patent Application Publication
(10) Pub. No.: US 2015/0182970 A1
(43) Pub. Date: Jul. 2, 2015

(54) FEED HOPPER

(71) Applicant: SANDVIK INTELLECTUAL PROPERTY AB, Sandviken (SE)

(72) Inventors: Axel Bergman, Malmo (SE); Bengt-Arne Eriksson, Svedala (SE); Fredrik Eriksson, Malmo (SE); Mikael M. Larsson, Eslov (SE); Patric Malmqvist, Svedala (SE)

(21) Appl. No.: 14/421,411

(22) PCT Filed: Jun. 20, 2013
(86) PCT No.: PCT/EP2013/062882

§ 371 Date: Feb. 12, 2015

(30) Foreign Application Priority Data
Aug. 13, 2012 (EP) 12180291.2

(51) Int. Cl. B02C 2/00; B02C 23/02

(52) U.S. Cl. CPC B02C 2/007; B02C 23/02

(57) ABSTRACT

A crusher feed hopper includes a plurality of guide lugs for correct alignment and mounting of additional components, such as a feed distributor and hopper wall protection insert. The guide lugs are positioned at an uppermost region of the hopper and mate with corresponding regions of the detachable hopper components to avoid incorrect mounting.

### FIELD OF INVENTION

The present invention relates to a crusher feed hopper and in particular, although not exclusively, to a hopper having a plurality of guide lugs that project from an upper region of the hopper and are configured to facilitate correct mounting of additional components to the hopper.

### BACKGROUND ART

Gyratory crushers are used for crushing ore, mineral and rock material to smaller sizes. Typically, the crusher comprises a crushing head mounted upon an elongate main shaft. A first crushing shell is mounted on the crushing head and a second crushing shell is mounted on a frame such that the first and second crushing shells define together a crushing gap through which the material to be crushed is passed. A driving device positioned at a lower region of the main shaft and is configured to rotate an eccentric assembly arranged about the shaft to cause the crushing head to perform a gyratory pendulum movement and crush the material introduced in the crushing gap. Example gyratory crushers are described in WO 2004/110626; WO 2010/123431and WO 2012/005651.

Similarly, vertical shaft impact crushers (VSI-crushers) are used in many applications for crushing hard material like rocks, ore etc., with examples described in WO 2004/020103 and WO 2010/042025.

Common to the various types of crushers is the need for the controlled feeding of material into the crusher in order to optimise the crushing action and crusher efficiency. Typically, a feed hopper is mounted at the crusher inlet and acts to guide material into the crushing zone. In some situations the operation of the crusher may be disrupted by problems in the feeding flow of material. Such problems reduce crushing efficiency and increase the need for maintenance work. To try and mitigate this, hoppers are typically fitted with an upper feed distributor through which material is fed into the hopper. Additionally, to reduce wear and damage to the hopper walls a protective insert is usually mounted within the hopper chamber. Furthermore, if maintenance work is required or indeed if the crusher is required to be disassembled for transport, it is necessary to lift the hopper vertically from the crusher. Lifting points, in the form of hoops are conventionally fastened directly onto the upper region of the hopper at an annular rim.

However, it is not uncommon with conventional hoppers for the feed distributor to be mounted incorrectly resulting in the non-optimised distribution of material into the crusher and hence a reduction of crusher efficiency and performance. Incorrect mounting of protective inserts at the upper wall is also a frequently encountered problem resulting in the protection of wrong sections of the hopper and accordingly premature wear or irreparable damage. What is required is a crusher hopper that addresses the above problem.

### SUMMARY OF THE INVENTION

It is an objective of the present invention to provide a crusher feed hopper that facilitates correct mounting of other components to the hopper such as a feed distributor and a hopper protective insert. It is a further objective to minimise any additional features and components forming part of the hopper to achieve the present objective. In particular, to increase transport efficiency and the use of raw materials, it is an objective to provide multi functional features at the hopper that contribute to reducing the overall weight of the crusher.

Accordingly, the inventors provide a crusher feed hopper having guide lugs that serve at least two functions. In a first mode, the guide lugs are configured to mate with mounting regions of additional hopper components such as feed distributors and hopper inserts. According to a specific implementation, the guide lugs are formed by projections extending upwardly from an upper rim of the hopper and are distributed circumferentially around a longitudinal axis of the hopper. These upwardly projecting lugs are configured to mate with suitable bore holes or recesses in the feed distributor and protective insert to ensure correct alignment and mounting at the hopper via a male and female mating relationship.

In a second mode of operation, the guide lugs are capable of mounting lifting hoops or anchorage bodies to allow cranes and the like to vertically raise and lower the hopper and the crusher via attachment of belts, chains and the like.

According to a first aspect of the present invention there is provided a crusher feed hopper for mounting upon a crusher comprising: at least one wall defining an internal hopper chamber through which material to be crushed is fed to the crusher; the hopper having an uppermost end to be positioned furthest from the crusher, the uppermost end configured to provide a mounting region for a feed distributor and a hopper wall protection insert; characterised by: a plurality of guide lugs provided at a region of the uppermost end and configured to mate with regions of the feed distributor and protection insert to provide correct alignment and mounting of the feed distributor and the protection insert at the hopper.

The term ‘guide lugs’ includes a body, hole and/or formation at the hopper that is capable with interengaging with a corresponding body, hole and/or formation at an additional demountable components such as a feed distributor and a hopper wall protection insert.

Accordingly, the hopper may comprise a plurality of guide bore holes configured to receive a plurality of projections extending from one or more of the additional demountable components. Preferably, the guide lugs comprise projections projecting outwardly or upwardly from the hopper.

Preferably, the at least one wall comprises a frusto cone shaped profile. Preferably, the at least one wall is orientated to be inwardly projecting from the uppermost end to a lowermost end relative to a longitudinal axis of the hopper. Optionally, the wall is orientated at an angle in the range 3° to 7° relative to the longitudinal axis and more preferably substantially 5°.

Preferably, the uppermost end comprises a mounting rim aligned transverse to the at least one wall wherein the guide lugs project upwardly from the rim. Preferably, the mounting rim extends radially outward from the wall and wherein each guide lug is positioned at a region radially outside the wall external to the hopper chamber. Preferably, the guide lugs comprise a length that extends substantially parallel with a longitudinal axis of the hopper.

Preferably, the guide lugs each comprise a through bore that extends from a top edge to a bottom edge of each guide lug.

When the guide lugs are configured in their second mode, the hopper further comprises a plurality of lifting mounts upwardly extending from the uppermost end of hopper to allow the hopper to be raised and lowered relative to the crusher, the lifting mounts releasably mounted at each respective guide lug via each of the through bores.

Optionally, at least a portion of the guide lugs comprises a hollow cylindrical shape profile. As will be appreciated, the guide lugs may comprise any shape profile including any polygonal shape cross sectional profile.

Preferably, the hopper further comprises additional demountable components, including in particular, a feed distributor and a hopper wall protection insert mounted at the hopper via engagement with the guide lugs. Preferably, the protection insert comprises a mounting flange to mate with the uppermost end of the hopper, the flange comprising a plurality of bore holes to receive respectively the guide lugs and provide correct alignment and mounting of the protection insert at the hopper. Preferably, the feed distributor comprises a plurality of bore holes to receive respectively the guide lugs and provide correct alignment and mounting of the feed distributor at the hopper.

Optionally, the hopper comprises six guide lugs projecting upwardly from the uppermost end, the guide lugs distributed circumferentially around a longitudinal axis of the hopper. As will be appreciated, the present invention may comprise any number of guide lugs distributed uniformly or non-uniformly circumferentially around the longitudinal axis and positioned at the uppermost region of the hopper wall. In particular, the hopper may comprise 2, 3, 4, 5, 6, 7, 8, 9 or 10 guide lugs.

Preferably, the hopper further comprises a hopper hatch positioned at the hopper wall configured to allow access through the hopper wall into the internal hopper chamber.

According to a second aspect of the present invention there is provided a gyratory crusher comprising a feed hopper as described herein.

### BRIEF DESCRIPTION OF DRAWINGS

A specific implementation of the present invention will now be described, by way of example only, and with reference to the accompanying drawings, in which:

FIG. 1 is an external side view of a hopper comprising a plurality of guide lugs positioned at an uppermost end, the hopper suitable for mounting upon a crusher according to a specific implementation of the present invention;

FIG. 2 is a perspective view of the uppermost end of the hopper of FIG. 1 at a region of the guide lugs;

FIG. 3 is a cross sectional side view of one of the guide lugs according to a second mode of use to attach lifting mounts to the hopper uppermost end;

FIG. 4 is a perspective view of the hopper of FIG. 1 with a feed distributor mounted upon the guide lugs in a first mode of use;

FIG. 5 is a perspective view of the hopper of FIG. 1 with the feed distributor removed for illustrative purposes to show the mounting of a hopper wall protection insert seated at the guide lugs;

FIG. 6 is a cross sectional side view of an upper region of the hopper of FIG. 1 with the feed distributor and wall protection insert of FIGS. 4 and 5 mounted in position via the guide lugs.

### DETAILED DESCRIPTION OF PREFERRED EMBODIMENT OF THE INVENTION

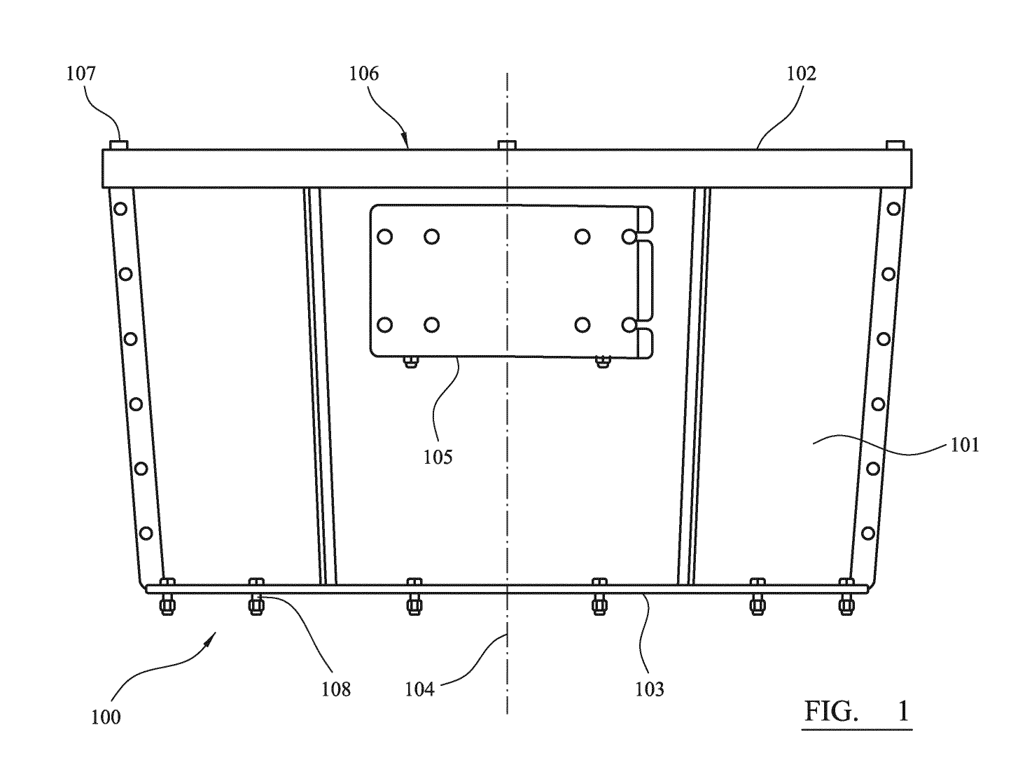

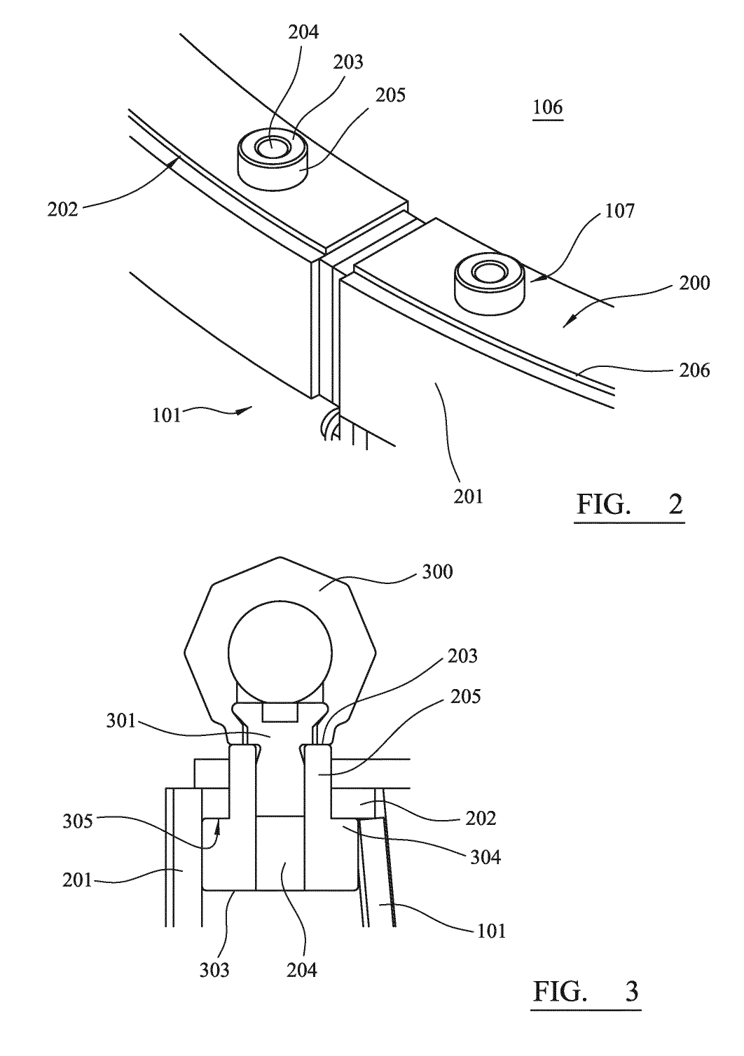

Referring to FIGS. 1 and 2, hopper 100 comprises a main hopper side wall 101 that extends circumferentially around a central longitudinal axis 104 of hopper 100. Wall 101 extends from an uppermost end 102 to a lowermost end 103 with end 103 suitable for mounting upon a crusher (not shown). Accordingly, uppermost end 102 is positioned furthest from the crusher (not shown). Hopper 101 is mounted at the crusher, or an intermediate component part, via mounting bolts 108 at lowermost end 103.

To assist with the directing and feeding of material to be crushed through hopper 100, hopper wall 101 is orientated to taper inwardly from uppermost end 102 towards lower end 103 relative to longitudinal axis 104. That is, relative to axis 104, wall 101 is tangential at an angle of substantially 5° to define a frusto cone shaped profile. Accordingly, a cross sectional area (relative to axis 104) of lowermost end 103 is less than a corresponding cross sectional area at uppermost end 102.

Wall 101 defines an internal hopper chamber 106 extending between uppermost and lowermost ends 102, 103. To allow access into chamber 106, a hatch 105 having a door and frame, is mounted at wall 101 being common to conventional crusher hoppers.

A plurality of guide lugs 107 projects upwardly from the uppermost end 102 and comprise a length that is aligned substantially with longitudinal axis 104. As detailed in FIG. 2, wall 101 is terminated at the uppermost end 102 by an annular rim 202 that also extends circumferentially around axis 104. Rim 202 projects radially outward from wall 101 and comprises an uppermost facing surface 200 that is terminated at its radially outermost edge 206 by a rim wall 201 that projects downwardly from edge 206 towards lowermost end 103. Rim wall 201 is aligned substantially parallel with axis 104 and comprises an axial length that slightly greater than the radial length of rim 202 and is orders of magnitude shorter than an axial length of hopper wall 101 between ends 102 and 103.

Each guide lug 107 comprises a substantially hollow cylindrical shape profile and projects upwardly from rim surface 200. The portion of each guide lug 107 that extends upwardly beyond rim surface 200 comprises a cylindrical wall 205 that is terminated by an upper annular face 203. A through bore 204 extends through the cylindrical body of guide lug 107 and is aligned substantially parallel with main axis 104.

As illustrated in FIG. 3, each guide lug 107 extends below rim 200 and is positioned between the outer rim wall 201 and a region of upper wall 101. At the region below annular rim 202, each guide lug 107 flares outwardly in its axial direction so as to form a locking shoulder 304 that abuts a lower facing surface 305 of rim 202. This configuration prevents each guide lug 107 from being displaced vertically upward when configured in a second mode for attachment of a suitable lifting mount in the form of an eyelet, hook or loop body 300. Through bore 204 extends from upper surface 203 to a lower surface 303 of guide lug 107. Eyelet body 300 is secured in position at guide lug 107 via a locking bolt 301 received within an upper region of through bore 204. Each through bore 204 comprises screw threads (not shown) to cooperate with corresponding screw threads (not shown) at bolt 301. When bolt 301 is secured in position within through bore 204, eyelet body 300 is releasably locked onto guide lug 107 via its upper surface 203.

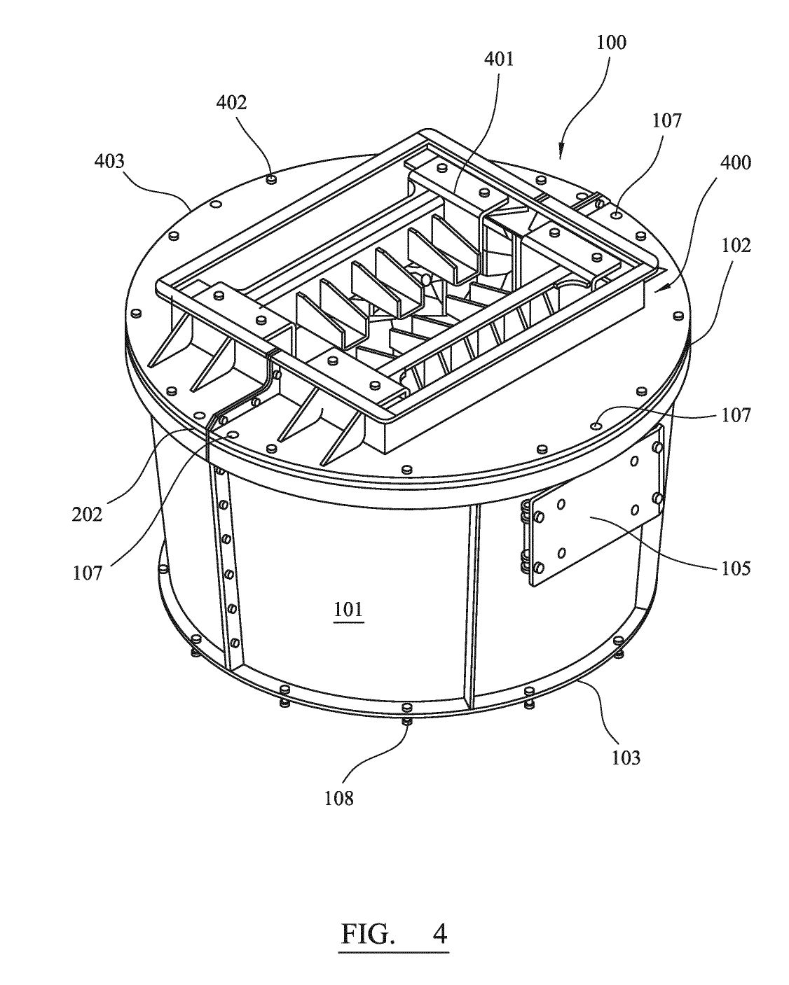

Referring to FIG. 4 a feed distributor 400 is mounted in position on top of hopper 100 at the uppermost end 102. Feed distributor 400 comprises a material inlet port 401 mounted at a substantially disk like body 403 of a suitable size and diameter to sit on top of annular rim 202 and substantially close the open upper end of hopper chamber 106. At a perimeter region of disk body 403, a plurality of circumferentially spaced guide bores 600 are provided referring to FIG. 6. A diameter of each bore 600 is slightly greater than a diameter of the upper cylindrical body of each guide lug 107 such that an upper region of guide lug 107 is accommodated within guide bore 600 when feed distributor 400 is located in position and seated upon annular rim 202. Distributor 400 is removably locked to the upper region of hopper 100 via anchoring bolts 402 also distributed circumferentially around axis 104. Anchorage bore 402 are secured through the disk body 403 via anchorage bores (not shown).

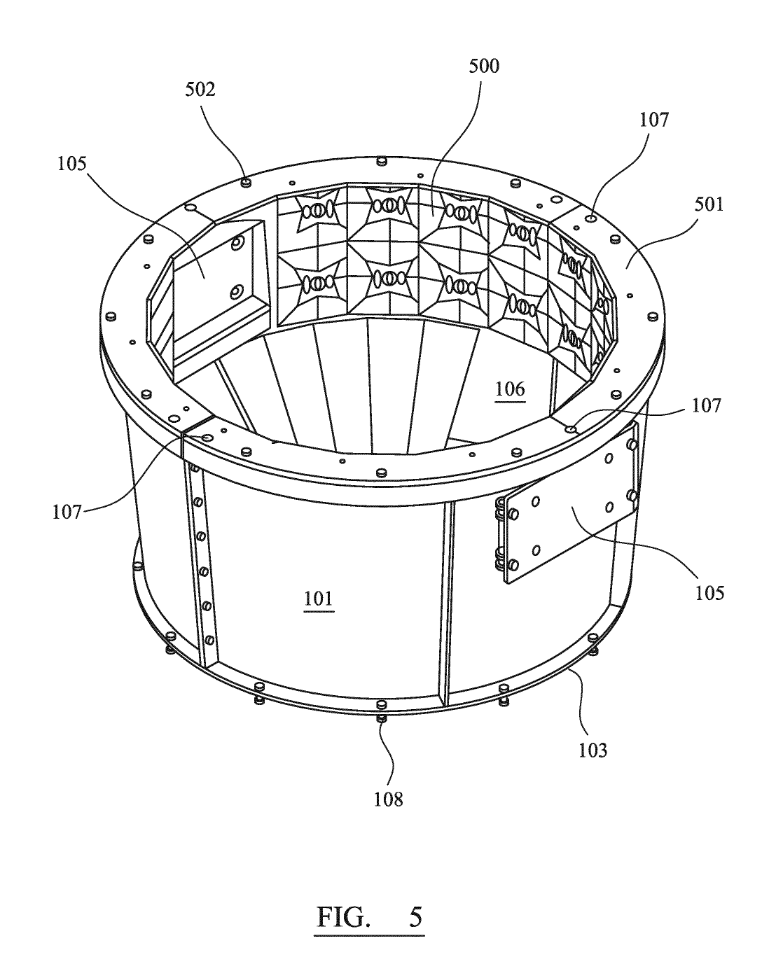

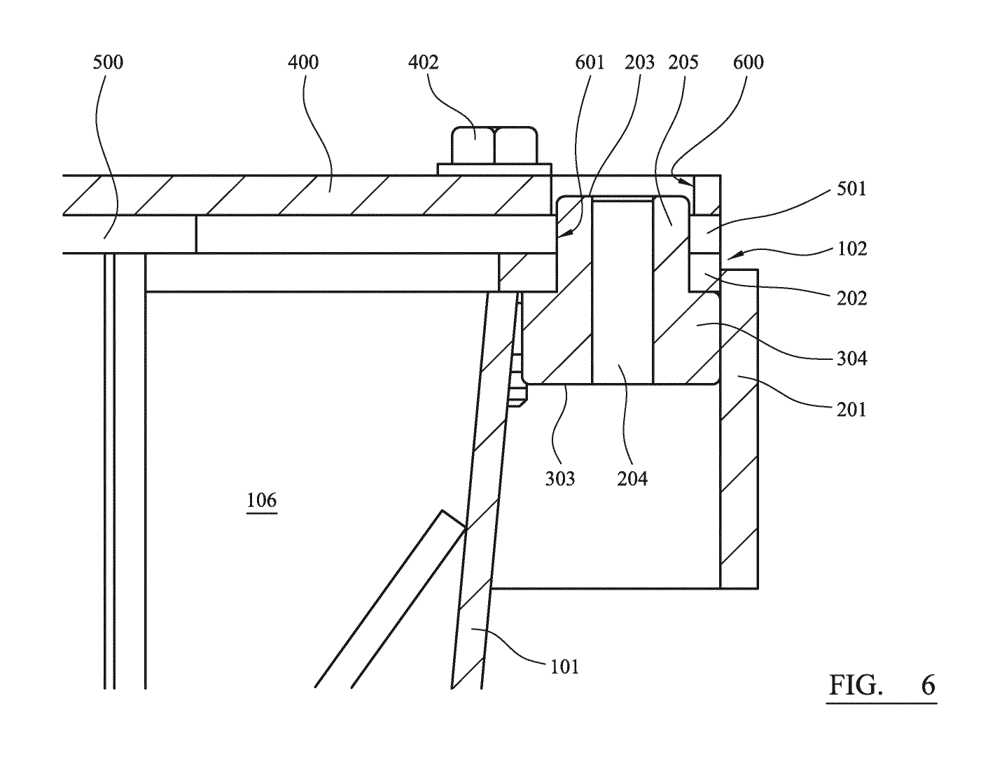

Referring to FIGS. 5 and 6, a hopper wall protection insert 500 is secured in position around an inner facing surface of hopper wall 101 at internal chamber 106. Protection insert 500 extends in the axial and circumferential directions over an inner region of wall 101 from uppermost end 102 towards lowermost end 103. Insert 500 further comprises a radially extending annular flange 501 that projects radially outward from an uppermost end of insert 500 in a similar plane to annular rim 202. Flange 501 is configured to sit on top of rim 202 and comprises a plurality of anchorage bores 502 distributed circumferentially around main axis 104. The position, size and distribution of anchorage bores 502 correspond to the anchorage bores (not shown) of the feed distributor 400 such that when seated in position at hopper 101 the anchorage bores are coaxial and receive anchorage bolts 402 that pass through and secure each component 400, 501 to hopper 100.

Referring to FIG. 6, protection insert 500 and in particular rim 501 further comprises guide bores 601 also circumferentially spaced and dimensioned as described with reference to the feed distributor 400. Both sets of guide bores 600, 601 are capable of being aligned coaxially at hopper 100 and configured to receive at least a portion of the cylindrical body of guide lugs 107 that projects upwardly from rim surface 200.

In use, protection insert 500 is lowered onto hopper 100 such that annular flange 501 sits on top of annular rim 202. This mounting is facilitated by the receiving of the guide lugs 107 within the respective guide bores 601. The feed distributor 400 is then lowered on top of the intermediate positioned protection insert 500. The anchorage bolts 402 are finally inserted in position to releasably lock the three components 400, 500 and 100 together. Incorrect alignment of the protection insert 500 and feed distributor 400 is prevented as the sets of guide bores 600, 601 receive the respective guide lugs 107. As shown in FIG. 6, a length by which the guide lugs 107 project upwardly from rim surface 200 is sufficient to ensure at least a part of the cylindrical bodies are received within guide bores 600, 601.

1. A crusher feed hopper for mounting upon a crusher comprising:
at least one wall defining an internal hopper chamber through which material to be crushed is fed to the crusher;
an uppermost end arranged to be positioned furthest from the crusher, the uppermost end providing a mounting region for a feed distributor and a hopper wall protection insert; and
a plurality of guide lugs provided at a region of the uppermost end and configured to mate with regions of the feed distributor and the protection insert to provide correct alignment and mounting of the feed distributor and the protection insert at the hopper.

2. The hopper as claimed in claim 1, wherein the at least one wall has a frusto cone shaped profile.

3. The hopper as claimed in claim 2, wherein the at least one wall is orientated to be inwardly projecting from the uppermost end to a lowermost end relative to a longitudinal axis of the hopper.

4. The hopper as claimed in claim 1, wherein the uppermost end includes a mounting rim aligned transverse to the at least one wall, the guide lugs projecting upwardly from the rim.

5. The hopper as claimed in claim 4, wherein the guide lugs have a length that extends substantially parallel with a longitudinal axis of the hopper.

6. The hopper as claimed in claim 4, wherein the mounting rim extends radially outward from the wall and wherein each guide lug is positioned at a region radially outside the wall external to the hopper chamber.

7. The hopper as claimed in claim 1, wherein the guide lugs each include a through bore that extends from a top edge to a bottom edge of each guide lug.

8. The hopper as claimed in claim 7, further comprising a plurality of lifting mounts upwardly extending from the uppermost end of hopper to allow the hopper to be raised and lowered relative to the crusher, the lifting mounts being releasably mounted at each respective guide lug via each of the through bores.

9. The hopper as claimed in claim 7, wherein at least a portion of the guide lugs has a hollow cylindrical shaped profile.

10. The hopper as claimed in claim 1, further comprising a feed distributor and a hopper wall protection insert mounted at the hopper via engagement with the guide lugs.

11. The hopper as claimed in claim 10, wherein the protection insert includes a mounting flange arranged to mate with the uppermost end of the hopper, the flange including a plurality of bore holes that receive the guide lugs and provide correct alignment and mounting of the protection insert at the hopper.

12. The hopper as claimed in claim 10, wherein the feed distributor includes a plurality of bore holes that receive the guide lugs (107) and provide correct alignment and mounting of the feed distributor at the hopper.

13. The hopper as claimed in claim 1, further comprising six guide lugs projecting upwardly from the uppermost end, the guide lugs being distributed circumferentially around a longitudinal axis of the hopper.

14. The hopper as claimed in claim 1, further comprising a hopper hatch positioned at the hopper wall and configured to allow access through the hopper wall into the internal hopper chamber.

15. A gyratory crusher comprising a feed hopper, the feed hopper including at least one wall defining an internal hopper chamber through which material to be crushed is fed to the crusher, an uppermost end arranged to be positioned furthest from the crusher, the uppermost end providing a mounting region for a feed distributor, a hopper wall protection insert, and a plurality of guide lugs provided at a region of the uppermost end and configured to mate with regions of the feed distributor and the protection insert to provide correct alignment and mounting of the feed distributor and the protection insert at the hopper.
